(19) United States
(12) Patent Application Publication
(10) Pub. No.: US 2020/0070094 A1
(43) Pub. Date: Mar. 5, 2020

(54) APPARATUS AND METHOD FOR THREE-DIMENSIONAL PHOTO-ELECTRODIALYSIS

(71) Applicant: UNIVERSITY OF IOWA RESEARCH FOUNDATION, Iowa City, IA (US)

(72) Inventors: Syed Mubeen Jawahar HUSSAINI, Iowa City, IA (US); David Cwiertny, Iowa City, IA (US); Joun Lee, Coralville, IA (US); Tim Young, Coralville, IA (US); Abdulsattar Hashim Ghanim Al Saedi, Iowa City, IA (US)

(73) Assignee: UNIVERSITY OF IOWA RESEARCH FOUNDATION, Iowa City, IA (US)

(21) Appl. No.: 16/467,900

(22) PCT Filed: Dec. 21, 2017
(86) PCT No.: PCT/US2017/067975

§ 371 Date: Jun. 7, 2019

Related U.S. Application Data
(60) Provisional application No. 62/437,244, filed on Dec. 21, 2016.

(51) Int. Cl. B01D 61/46; C02F 1/469; C25D 11/04; C02F 1/461; C25D 1/00

(52) U.S. Cl. CPC B01D 61/46; C02F 1/4693; C25D 11/045; C02F 2103/08; C25D 1/006; B01D 2313/345; C02F 1/46109

(57) ABSTRACT

A three-dimensional photo/electrodialysis unit includes four compartments. A first compartment holds a three-dimensional electrode and a group of one or more electrochemically active redox species. A first electroactive cation selective membrane couples the first compartment to a second compartment that provides a first feedstock. An electroactive anion selective membrane couples the second compartment to a third compartment that provides a second feedstock. And a second electroactive cation selective membrane couples the third compartment to a fourth compartment

### PRIORITY APPLICATION

This application claims priority to U.S. Provisional Application No. 62/437,244 which was filed on Dec. 21, 2016. The entire content of the application referenced above is hereby incorporated by reference herein.

### BACKGROUND

Current desalination technologies are often based on membrane separation and thermal distillation methods. Exemplary technologies include reverse osmosis and thermal distillation. Unfortunately, high capital expense with high energy demands makes reverse osmosis prohibitively expensive for wide scale adoption. Other unresolved problems in membrane based systems include membrane fouling and concentration polarization. Thermal distillation is expensive in terms of freshwater consumption and carbon footprint. For these and other reasons there is a need for the subject matter of the present disclosure.

### SUMMARY

A three-dimensional photo-electrodialysis unit includes a first compartment to hold a three-dimensional electrode and a group of one or more electrochemically active redox species. A first electroactive cation selective membrane couples the first compartment to a second compartment and the second compartment provides a first feedstock. An electroactive anion selective membrane couples the second compartment to a third compartment, and the third compartment provides a second feedstock. A second electroactive cation selective membrane couples the third compartment to a fourth compartment, and the fourth compartment holds a second group of one or more electrochemically active redox species.

### BRIEF DESCRIPTION OF THE DRAWINGS

FIG. 1 shows an illustration of an electrode-membrane assembly for a three-dimensional photo-electrodialysis unit in accordance with some embodiments of the present disclosure.

FIG. 2 shows an illustration of ion flow in a three-dimensional photo-electrodialysis unit in accordance with some embodiments of the present disclosure.

FIG. 3 shows an illustration of ion flow in the three-dimensional photo-electrodialysis unit including a detailed illustration of electroactive membranes in accordance with some embodiments of the present disclosure.

FIG. 4(a) shows an illustration of the fluid flow in a three-dimensional photo-electrodialysis unit in accordance with some embodiments of the present disclosure.

FIG. 4(b) shows an illustration of the potential driven ion-transport in a three-dimensional photo-electrodialysis unit in accordance with some embodiments of the present disclosure.

FIG. 5(a) shows an experimental setup in accordance with some embodiments of the present disclosure.

FIG. 5(b) shows a graph of conductivity versus time for a three-dimensional photo-electrodialysis unit and a planar electrode photo-electrodialysis unit in accordance with some embodiments of the present disclosure.

FIG. 6 shows an illustration of SEM images of nano-structured light absorbent materials in accordance with some embodiments of the present disclosure.

FIG. 7(a) shows a schematic diagram of an electrodialysis unit including compartments and membrane stacks, and employing a three-dimensional electrode in accordance with some embodiments of the present disclosure.

FIG. 7(b) shows an illustration of an electrodialysis unit with a set of peristaltic pumps and tanks of solution in accordance with some embodiments of the present disclosure.

FIG. 7(c) shows an illustration of a three-dimensional electrodialysis unit showing a porous carbon foam insert in accordance with some embodiments of the present disclosure.

FIG. 7(d) shows an illustration of an SEM image of a carbon foam electrode in accordance with some embodiments of the present disclosure.

FIG. 8(a) shows a graph of desalination performance for various electrode configurations in accordance with some embodiments of the present disclosure.

FIG. 8(b) shows a graph of conductivity versus time for different salt concentrations in accordance with some embodiments of the present disclosure.

FIG. 8(c) shows a graph of stability for a three-dimensional electrode in accordance with some embodiments of the present disclosure.

FIG. 9(a) shows an illustration of a diffusion cell set-up for a membrane selectivity measurement in accordance with some embodiments of the present disclosure.

FIG. 9(b) shows a graph of trans-membrane potential as a function of applied membrane potential with the dashed line representing the theoretical maximum trans-membrane potential in accordance with some embodiments of the present disclosure.

FIG. 10 shows an illustration of a step-by-step synthetic procedure for forming an electroactive membrane in accordance with some embodiments of the present disclosure.

FIG. 11 shows an illustration of a top-view SEM image of hollow polystyrene tubes formed inside a porous alumina membrane in accordance with some embodiments of the present disclosure.

FIG. 12 shows a block diagram of a three-dimensional photo-electrodialysis unit including a three-dimensional electrode in accordance with some embodiments of the present disclosure.

FIG. 13 shows a block diagram of an apparatus including one or more photocells in accordance with some embodiments of the present disclosure.

FIG. 14 shows a block diagram of an apparatus including a three-dimensional porous foam photo-electrode in accordance with some embodiments of the present disclosure.

FIG. 15 shows a block diagram of an apparatus including a solar cell in accordance with some embodiments of the present disclosure.

FIG. 16 shows a flow diagram of a method of forming a processed liquid feedstock from a starting liquid feedstock in accordance with some embodiments of the present disclosure.

FIG. 17 shows an illustration of an apparatus including a substantially spherical particle having a photo-active coating in accordance with some embodiments of the present disclosure.

FIG. 18 shows a flow diagram of a method of forming an electroactive membrane in accordance with some embodiments of the present disclosure.

### DESCRIPTION

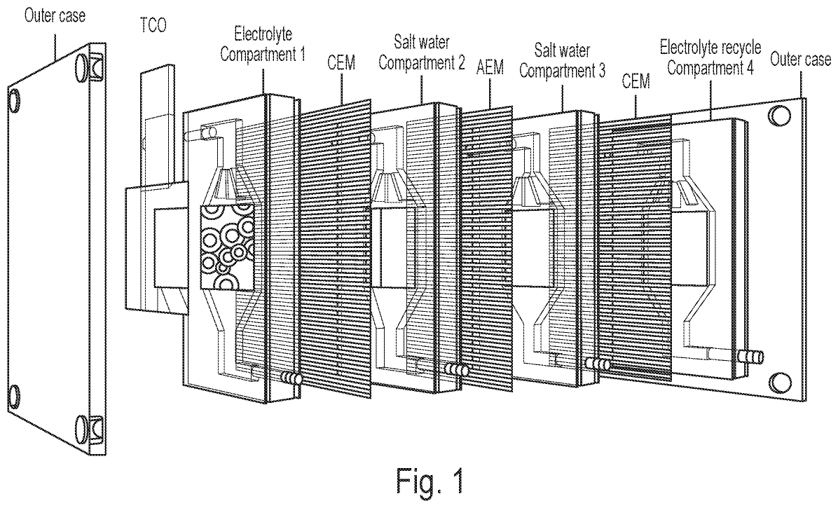

An exemplary photo-electrodialysis unit integrated with three dimensional electrodes is shown in FIGS. 1-9. The unit includes four functional compartments (numbered 1 through 4 and also referred to as first compartment, second compartment, third compartment and fourth compartment). Solutions containing earth abundant, electrochemically active redox species are circulated through compartments 1, and 4 (“electrolyte” compartments). A salt solution flows through compartments 2 and 3. Compartments 1-4 are ionically connected in series by alternating stacks of electrically active cation and anion exchange membranes (CEM and AEM).

A first exemplary pathway for achieving electrodialysis is illustrated schematically in FIG. 1. The process begins with light initiated charge transport. The circulating photocells are introduced into compartment 1. Under appropriate hydrodynamic conditions, the circulating photocells form a three-dimensional photo-electrode bed (packed) and are in electrical contact with the surface of the neighboring particles, as well as a transparent conducting oxide (TCO) electrode. The fixed TCO electrode functions as an electron transfer unit that transfers charge to/from the circulating photocell bed by a ‘contact charge transfer’ mechanism. Upon irradiation the suspended three-dimensional circulating photocells reduce (or oxidize) the redox active species in compartment 1, while the charges from the photocells are transferred through the TCO in compartment 1 to the electrode in compartment 4 that oxidizes (or reduces) the redox active species, thereby maintaining charge neutrality. The recycle compartment (compartment 4) provides mixing of oxidized and reduced electroactive species to reestablish electrochemical equilibrium.

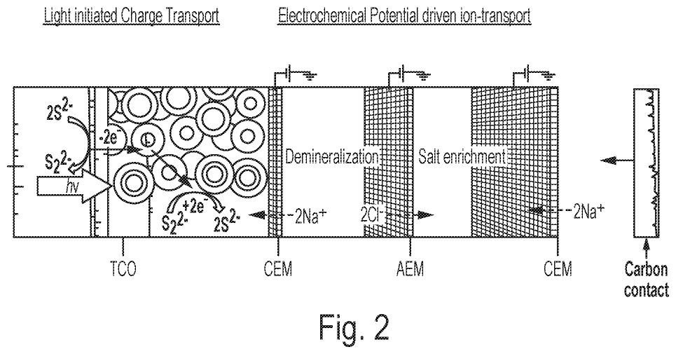

The process continues with electrochemical potential driven ion-transport. The charge transfer process described above creates the necessary potential difference to initiate ion transport across compartments 1 to 3 to maintain ion-neutrality. For the system shown in FIG. 2, the photo-electrochemical process creates an excess of S²⁻ ions in compartment 1, initiating transfer of two Na⁺ ions from compartment 2 to compartment 1 through the electrically activated cation selective membrane. This light-initiated ion transport event results in demineralization of compartment 2 and concentration of salts in compartment 3.

As described herein the terms “electroactive cation selective membrane” and “electroactive anion selective membrane” are sometime referred to as “electrically activated cation selective membrane” or “electrically activated anion selective membrane”, respectively. One of ordinary skill in the art will appreciate that in some embodiments the membranes maintain an electrostatic charge and in other embodiments they are coupled to a power source.

Use of a three-dimensional circulating electrode bed with the integrated electrically activated ion selective membrane results in improved performance. Specifically, under appropriate hydrodynamic conditions, a three-dimensional array of closely-spaced conducting particles (to which DC current is fed by a conducting rod) acts as an extension of the current collector surface, thereby enhancing operational currents. The electrically activated ion selective membrane efficiently transports ions across the membrane preventing membrane fouling caused by high concentration gradient built by the enhanced currents. It also increases the ion flux due to enhanced electrokinetic action. This is valuable for mass-transfer limited electrochemical processes like electrodialysis, which require operation at low current densities for efficient current utilization.

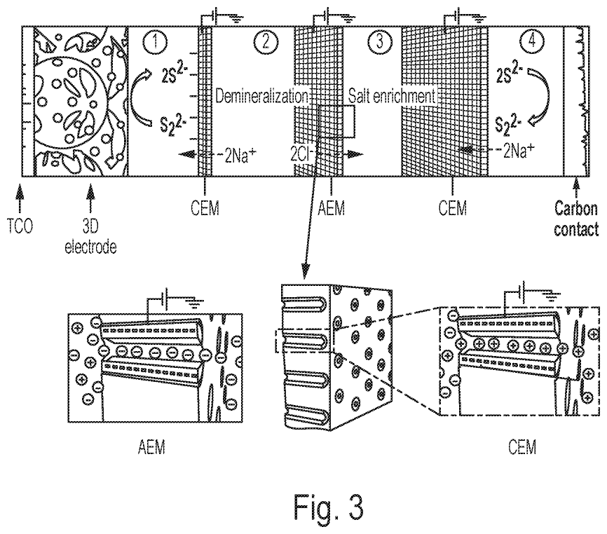

A second exemplary pathway for achieving electrodialysis is illustrated schematically in FIG. 3. The process begins with light initiated charge transport. A three dimensional porous foam photoelectrode is introduced into compartment 1 in contact with the transparent conducting oxide (TCO) electrode. The fixed TCO electrode acts as an electron transfer unit that transfers charge to and from the porous foam photo-electrode. Upon irradiation, the three-dimensional porous foam photo-electrode reduce (or oxidize) the redox active species in compartment 1, while the charges from the photo-electrode are transferred through the TCO in compartment 1 to the electrode in compartment 4 that oxidizes (or reduces) the redox active species, thereby maintaining charge neutrality. The recycle compartment (compartment 4) provides mixing of oxidized and reduced electroactive species to reestablish electrochemical equilibrium.

The process continues with electrochemical potential driven ion-transport. The charge transfer process described above creates the necessary potential difference to initiate ion transport across compartments 1 and 3 to maintain ion-neutrality. For the system in FIG. 3, the photo-electrochemical process creates an excess of S²⁻ ions in compartment 1, initiating transfer of two Na⁺ ions from compartment 2 to compartment 1 through the electrically activated cation selective membrane. This light-initiated ion transport event results in demineralization of compartment 2 and concentration of salts in compartment 3.

The large surface area of the foam electrode will act as an extension of the current collector surface enhancing the currents, thereby improving the device efficiency. The electrically activated ion selective membrane efficiently transports ions across the membrane preventing membrane fouling caused by high concentration gradient built by the enhanced currents.

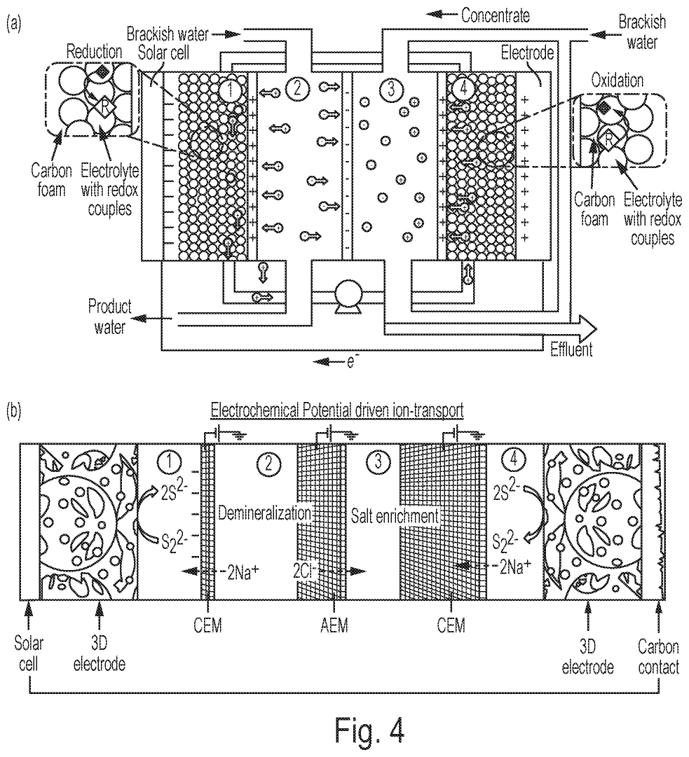

A third exemplary pathway for achieving electrodialysis is illustrated schematically in FIG. 4. The process begins with light initiated charge transport from the solar cell at the front of compartment 1. The three-dimensional porous foam electrode is attached onto the back-side of a solar cell to receive light initiated charges. Upon irradiation, the light initiated charge transport from the solar cell to the three-dimensional porous foam electrode reducing (or oxidizing) the redox active species in compartment 1, while the opposite charges from the solar cell are transferred to the three-dimensional porous foam electrode in compartment 4 oxidizing (or reducing) the redox active species, thereby maintaining charge neutrality. The recycle compartment (compartment 4) allows mixing of oxidized and reduced electroactive species to reestablish electrochemical equilibrium. One of ordinary skill in the art will appreciate that in embodiments that incorporate a solar cell the three dimensional electrode optionally will not need to be coated.

The process continues with electrochemical potential driven ion-transport. The charge transfer process described above creates the necessary potential difference to initiate ion transport between compartments 1 and 3 to maintain ion-neutrality. For the system in FIG. 4, the photo-electrochemical process creates an excess of S²⁻ ions in compartment 1, initiating transfer of two Na⁺ ions from compartment 2 to compartment 1 through the electrically activated cation selective membrane. This light-initiated ion transport event results in demineralization of compartment 2 and concentration of salts in compartment 3.

The large surface area of the foam electrode acts as an extension of the current collector surface, thereby significantly enhancing operational currents. The electrically activated ion selective membrane efficiently transports ions across the membrane preventing membrane fouling caused by high concentration gradient built by the enhanced currents.

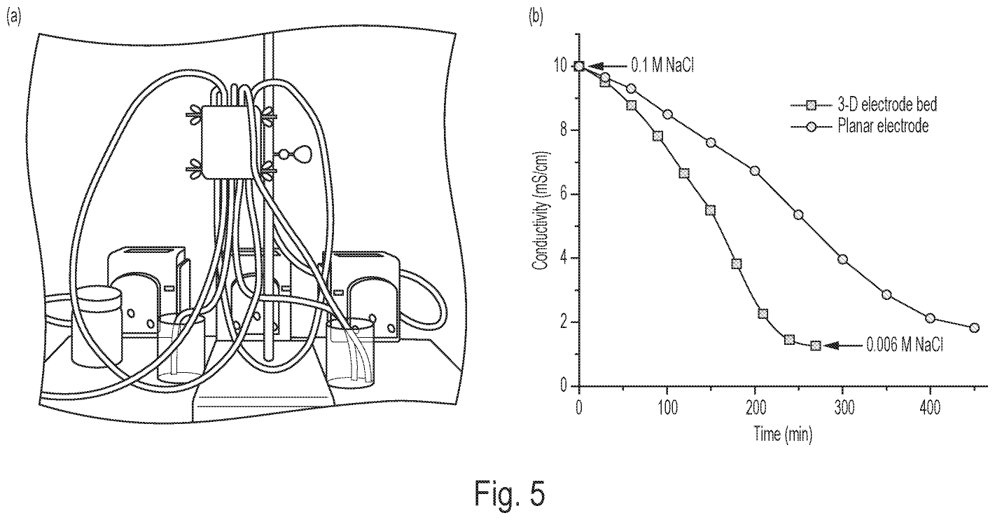

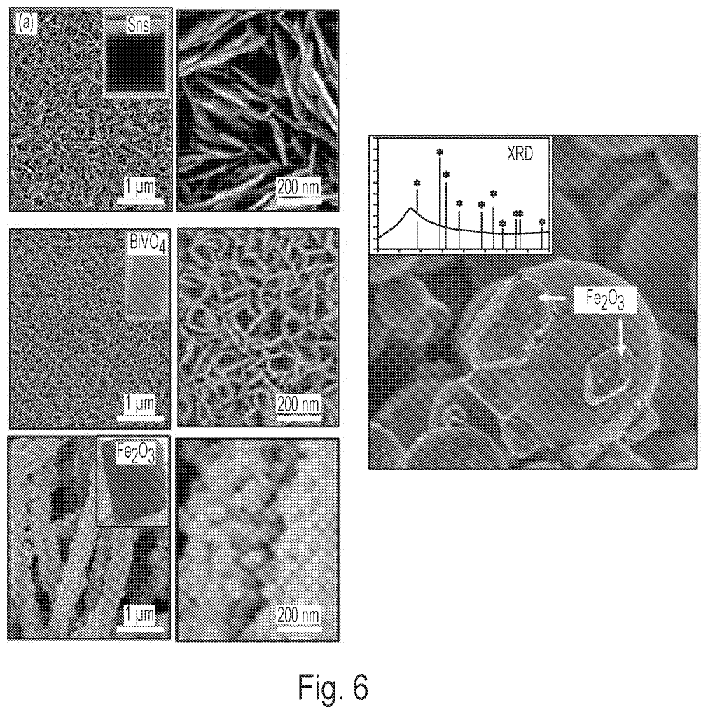

Electrodialysis results from an exemplary system of photocells are shown in FIG. 5. Compartment 1 was packed with micron-sized (˜20 micron diameter) spheres to recreate the three-dimensional electrode bed configuration. A peristaltic pump was used to flow 0.1 M NaCl solution through compartments 2 and 3. The sulfide redox couple (0.1 M Na₂S/0.1 M Na₂S₂) flows across compartments 1 and 4 (FIG. 5(a)). All solutions were circulated at a rate of 2 mL/min. Electrodialysis operation was carried under constant current (20 mA; delivered using an external galvanostat/potentiostat) mode, and desalination progress was monitored by measuring potential and solution conductivity as a function of time (FIG. 3(b)). For three-dimensional electrode beds, a steady state potential of 0.35 V was required to achieve ˜95% desalination efficiency [(initial concentration− final concentration)/initial concentration] in ˜4.5 h. This corresponds to a total energy requirement of 0.05 kWh. In comparison, desalination experiments with planar stainless electrodes (FIG. 5(b)) required ˜7 h to achieve 90% desalination efficiency. They also required a steady state potential of 0.9 V, corresponding to a total energy requirement of 0.112 kWh, a 2.3-fold increase compared to three-dimensional electrodes. FIG. 6 shows SEM images of various exemplary candidate semiconductor materials and photocells coated with Fe₂O₃.

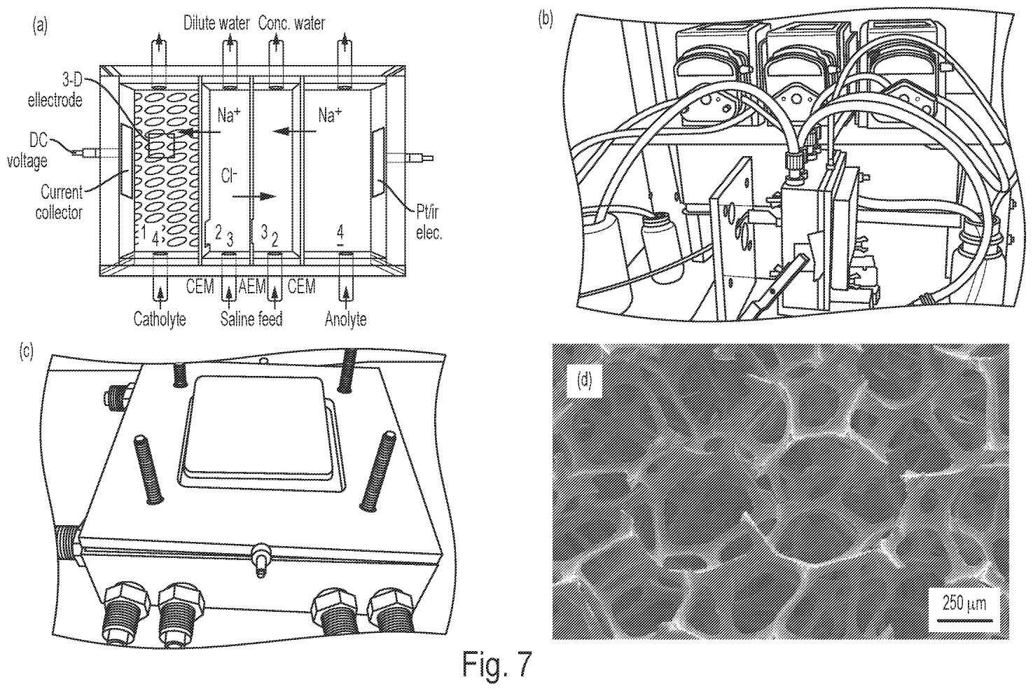

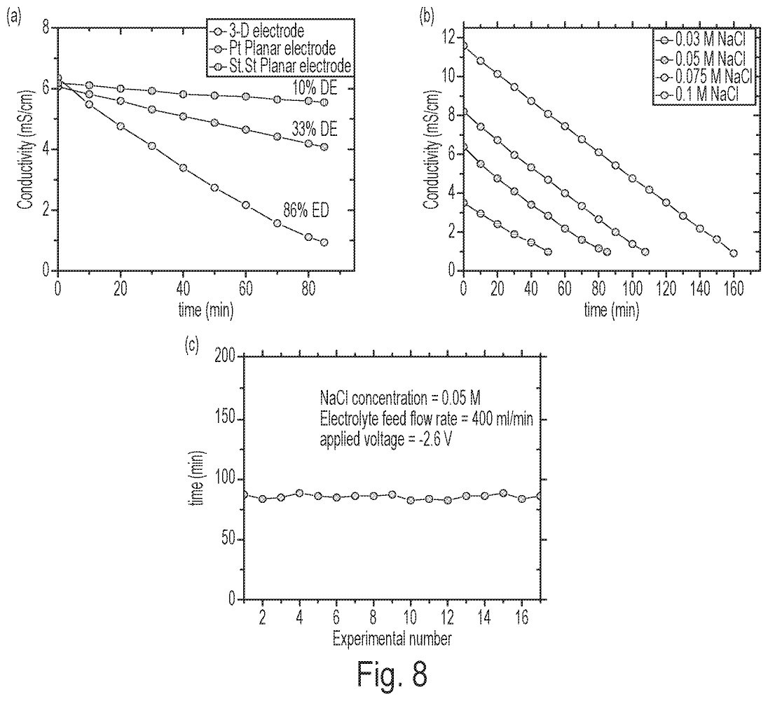

Electrodialysis results from an exemplary system of porous foam electrodes are shown in FIGS. 7-8. A schematic of the electrodialysis unit with a sheet of carbon foam introduced in compartment 1 is shown in FIG. 7(a). Photographs of the electrodialysis unit with peristaltic pumps are shown in FIGS. 7(b) and (c), and a SEM image showing the internal structure of the carbon foam is shown in FIG. 7(d). A peristaltic pump was used to flow 0.1 M NaCl solution through compartments 2 and 3, and sulfide redox couple (0.1 M Na₂S/0.1 M Na₂S₂) across compartments 1 and 4. A set of three peristaltic pumps BT100-2J with head YZ1515x and silicon tube number 18 (Longer Instruments, USA) were used to circulate the concentrated saline water and rinsing electrolyte. Tanks of 375 ml, and 125 ml, of saline water were holding dilute and concentrated compartments respectively. BioLogic VSP-300 and SP-50 potentiostats with EC-Lab software (Biologic) were used in these experiments to supply DC power. Electrodialysis performance for these three electrodes was conducted under the limiting potential to avoid water splitting. A high flow rate for 0.05 M NaCl in three-dimensional electrode achieved 86% of desalination efficiency (DE) in 85 min reaching drinking water level, while, the state-of-the-art planar electrode achieved just 33% of DE for platinum planar electrode, and 10% of DE for stainless steel planar electrode.

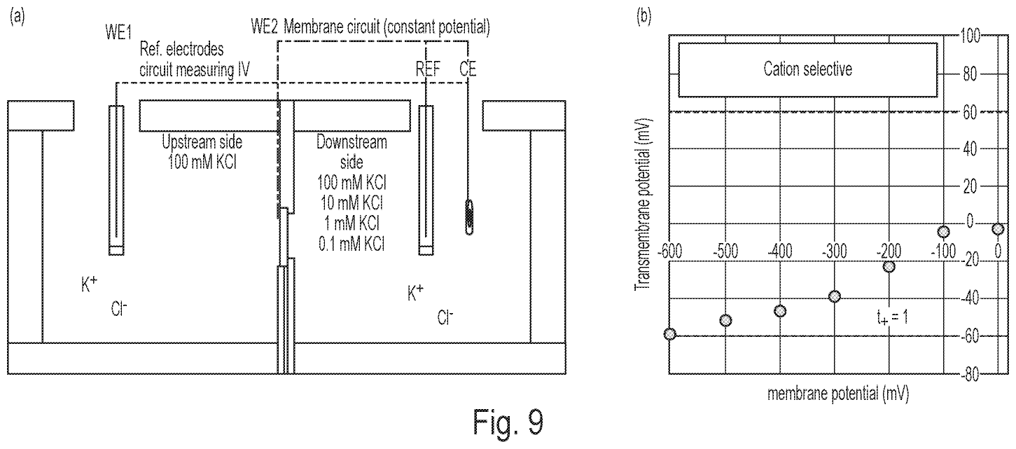

FIG. 9 shows the schematic of the experimental set-up for the selectivity measurement of the electrically activated ion selective membrane integrated into the three-dimensional photo-electrodialysis unit that prevents membrane fouling due to enhanced performance. The use of these electroactive membranes as ion-exchange membranes with ion-selectivity imparted based on the applied electric field (i.e., controlling the ion-selectivity by injecting excess charge into the membrane). For example, excess negative charges can be created at the inner walls by applying a negative potential. Ions with the same charge will get repelled and counter-ions will flow through.

A first exemplary embodiment (embodiment 1) is a three-dimensional photo-electrodialysis unit (and a method of making) that includes:

a) a solution compartment (compartment 1) containing electrochemically active redox species such as sulfur (S²⁻/S₂²⁻), Iron (Fe²⁺/Fe³⁺), Cobalt (Co²⁺/Co³⁺), Selenium (Se²⁻/Se₂²⁻), Tellurium (Te²⁻/Te₂²), Nickel (Ni²⁺/Ni³⁺), Manganese (Mn²⁺/Mn⁴⁺), Tin (Sn²⁺/Sn⁴⁺);

b) a solution compartment (compartment 1) containing above mentioned electrochemically active redox species with three-dimensional packed bed photocells. Photocells are micron-size hydrophilic glass beads coated with nanostructured photo-active solids;

c) a solution compartment 2 containing salt water feedstock;

d) an effluent compartment (compartment 3) containing salts collected from the water feedstock and compartment 4

e) a recycle compartment (compartment 4) containing electrochemically active redox species as in compartment 1;

f) a cation-selective membrane separating compartments 1 and 2, and compartments 3 and 4; and

g) a anion-selective membrane separating compartments 2 and 3;

The salt water feedstock can include sea water, inland brackish water, drinking water containing trace amounts of pollutants (including perfluorinated compounds and metal ion pollutants), produced water from oil and natural gas wells, waste water (e.g., from complex organic chemical industries, pharmaceutical processing, pesticide manufacturing, hydrocarbon refining, detergents, plastics, pulp and paper mills, textile dyes, produced water, agricultural, biofuels, chemical manufacturing, toxic hydrogen sulfide, hydrogen bromide, hydrogen chloride, municipal wastewater, iron and steel industry, coal plants, and tannery). The feedstock can include chemical substances (e.g., organic molecules, inorganic molecules, celluloses, hydrocarbons, non-biocompatible pollutants, alcohols, ethanol, methanol, isopropyl alcohol, pesticides, glucose, phenols, carboxylic acids, cyanide, ammonia, acetic acid, dyes, surfactants, chlorophenols, anilines, perfluorinated compounds and its families, metal ions (including lead, mercury, chromium), oxalic acid, and tartaric acid).

Operation of a photo-electrodialysis cell gives rise to oxidized and reduced gaseous and liquid co-product(s) in compartments 1 and 2. Such reduced co-products can include hydrogen, CO₂ reduction products such as methane, formic acid, oxalic acid and oxidized co-products can include oxygen, chlorine, bromine, hypochlorites, caustic solution and iodine.

A second exemplary embodiment (embodiment 2) is a nanostructured micron sized photocell (and a method of making) that includes:

a) a micron size spherical bead made of glass, carbon, or semiconductors; and

b) a nanostructured photoactive material that is deposited immediately on top of the micron size glass bead, the photoactive solid being made of a semiconductor material with the desired thickness to produce a photo-generated current output that is substantially equal to the ion-transport rates across the membrane.

In embodiment 2, exemplary nanostructured semiconducting materials include an electrodeposited (ED) iron oxide, ED cadmium telluride, ED copper indium di-selenide (CuInSe₂), ED cadmium selenide, ED cadmium sulfide, ED copper oxide, chemical bath deposited tin sulfide, electrospun iron oxide, ED silicon, Ed copper sulfide, ED copper zinc tin sulfide, ED bismuth vanadate, ED gallium arsenide, ED gallium phosphide, ED indium phosphide. FIG. 4 shows fabricated structures using tin sulfide, bismuth vanadate, and iron oxide.

Exemplary micron size glass beads include meso/nanoporous silica, meso/nanoporous zirconia, meso/nanoporous hafnia. The semiconductor materials can be deposited both outside and inside micron size glass beads to increase overall surface area.

A third exemplary embodiment (embodiment 3) is a three-dimensional photo-electrodialysis unit (and a method of making) that includes:

a) a solution compartment (compartment 1) containing electrochemically active redox species such as sulfur (S²⁻/S₂²⁻), Iron (Fe²⁺/Fe³⁺), Cobalt (Co²⁺/Co³⁺), Selenium (Se²⁻/Se₂²⁻), Tellurium (Te²⁻/Te₂²⁻), Nickel (Ni²⁺/Ni³⁺), Manganese (Mn²⁺/Mn⁴⁺), Tin (Sn²⁺/Sn⁴⁺);

b) a solution compartment (compartment 1) containing the electrochemically active redox species described above with three-dimensional photo-electrode. The three-dimensional electrode includes a photo-active porous conductive foam;

c) a solution compartment 2 containing salt water feedstock;

d) an effluent compartment (compartment 3) containing salts collected from the water feedstock and compartment 4;

e) a recycle compartment (compartment 4) containing electrochemically active redox species as in compartment 1;

f) a cation-selective membrane separating compartments 1 and 2, and compartments 3 and 4; and

g) an anion-selective membrane separating compartments 2 and 3.

The salt water feedstock can include sea water, inland brackish water, drinking water containing trace amounts of pollutants (including perfluorinated compounds and metal ion pollutants), produced water from oil and natural gas wells, waste water (e.g., from complex organic chemical industries, pharmaceutical processing, pesticide manufacturing, hydrocarbon refining, detergents, plastics, pulp and paper mills, textile dyes, agricultural, biofuels, chemical manufacturing, toxic hydrogen sulfide, hydrogen bromide, hydrogen chloride, municipal wastewater, iron and steel industry, coal plants, and tannery). The feedstock can include chemical substances (e.g., organic molecules, inorganic molecules, celluloses, hydrocarbons, non-biocompatible pollutants, alcohols, ethanol, methanol, isopropyl alcohol, pesticides, glucose, phenols, carboxylic acids, cyanide, ammonia, acetic acid, dyes, surfactants, chlorophenols, anilines, perfluorinated compounds and its families, metal ions (including lead, mercury, chromium), oxalic acid, and tartaric acid).

Operation of a photo-electrodialysis three-dimensional electrodialysis cell gives rise to oxidized and reduced gaseous and liquid co-product(s) in compartments 1 and 2. Such reduced co-products can include hydrogen, CO₂ reduction products such as methane, formic acid, oxalic acid and oxidized co-products can include oxygen, chlorine, bromine, and iodine.

A fourth exemplary embodiment (embodiment 4) is a three-dimensional porous foam electrode (and a method of making) that includes:

a) a porous foam made of indium tin oxide, fluorin-doped tin oxide, carbon, nickel, iron, cobalt, copper, gold, silver, platinum, ruthenium, and the alloys of thereof;

b) a nanostructured photoactive material that is disposed immediately on top of the porous foam, the photoactive solid being made of a semiconductor material with the desired thickness to produce a photo-generated current output that is substantially equal to the ion-transport rates across the membrane.

In embodiment 4, the nanostructured semiconducting material can be an electrodeposited (ED) iron oxide, ED cadmium telluride, ED copper indium di-selenide (CuInSe₂), ED cadmium selenide, ED cadmium sulfide, ED copper oxide, chemical bath deposited tin sulfide, electrospun iron oxide, ED silicon, Ed copper sulfide, ED copper zinc tin sulfide, ED bismuth vanadate, ED gallium arsenide, ED gallium phosphide, ED indium phosphide. FIG. 4 shows fabricated structures using tin sulfide, bismuth vanadate, and iron oxide.

Exemplary materials for the fabrication of the three-dimensional porous foam electrode include porous carbon foam, porous nickel foam, porous cobalt foam, porous iron foam, and porous silicon foam. The semiconductor materials can be deposited both outside and inside the porous foam electrode to increase overall surface area.

A fifth exemplary embodiment (embodiment 5) is a three-dimensional photo-electrodialysis unit (and a method of making) that includes:

a) a solar cell that generates light initiated charges

b) a solution compartment (compartment 1) containing electrochemically active redox species such as sulfur (S²⁻/S₂²⁻), Iron (Fe²⁺/Fe³⁺), Cobalt (Co²⁺/Co³⁺), Selenium (Se²⁻/Se₂²⁻), Tellurium (Te²⁻/Te₂²⁻), Nickel (Ni²⁺/Ni³⁺), Manganese (Mn²⁺/Mn⁴⁺), Tin (Sn²⁺/Sn⁴⁺);

b) a solution compartment (compartment 1) containing above mentioned electrochemically active redox species with three-dimensional electrode. The three-dimensional electrode is porous conductive foam;

c) a solution compartment 2 containing salt water feedstock;

d) an effluent compartment (compartment 3) containing salts collected from the water feedstock and compartment 4;

e) a solution compartment (compartment 4) containing above described three-dimensional porous conductive foam electrode;

f) a recycle compartment (compartment 4) containing electrochemically active redox species as in compartment 1;

g) a cation-selective membrane separating compartments 1 and 2, and compartments 3 and 4; and

h) an anion-selective membrane separating compartments 2 and 3;

The salt water feedstock can include sea water, inland brackish water, waste water (e.g., from complex organic chemical industries, pharmaceutical processing, pesticide manufacturing, hydrocarbon refining, detergents, plastics, pulp and paper mills, textile dyes, agricultural, biofuels, chemical manufacturing, toxic hydrogen sulfide, hydrogen bromide, hydrogen chloride, municipal wastewater, iron and steel industry, coal plants, and tannery). The feedstock can include chemical substances (e.g., organic molecules, inorganic molecules, celluloses, hydrocarbons, non-biocompatible pollutants, alcohols, ethanol, methanol, isopropyl alcohol, pesticides, glucose, phenols, carboxylic acids, cyanide, ammonia, acetic acid, dyes, surfactants, chlorophenols, anilines, oxalic acid, and tartaric acid).

Operation of such a photo-electrodialysis three-dimensional electrodialysis cell gives rise to oxidized and reduced gaseous and liquid co-product(s) in compartments 1 and 2. Such reduced co-products can include hydrogen, CO₂ reduction products such as methane, formic acid, oxalic acid and oxidized co-products can include oxygen, chlorine, bromine, and iodine.

A sixth exemplary embodiment (embodiment 6) is a three-dimensional porous foam electrode (and a method of making) that includes:

a) a solar cell that is made of Si, GaAs, CdTe, CdSe, GaN, CIGS, CdS, and the mixture of thereof; and

b) a porous foam made of indium tin oxide, fluorin-doped tin oxide, carbon, nickel, iron, cobalt, copper, gold, silver, platinum, ruthenium, and the alloys of thereof.

Electroactive membranes can enhance efficiency and operational lifetimes of water treatment systems. The separator or membrane is the system component governing the life cycle and energy costs of membrane-based water treatment processes. Electroactive membranes can be periodically triggered using a small DC voltage source to prevent supersaturation (or depletion) of ions near the membrane surface that causes concentration polarization losses.

An electroactive membrane architecture suitable for use in connection with the photo-electrodialysis unit described above includes a hollow inorganic membrane including vertical arrays of carbon nanotubes inside porous anodic aluminum oxide (AAO) membranes with tunable ion selectivity, porosity and pore density.

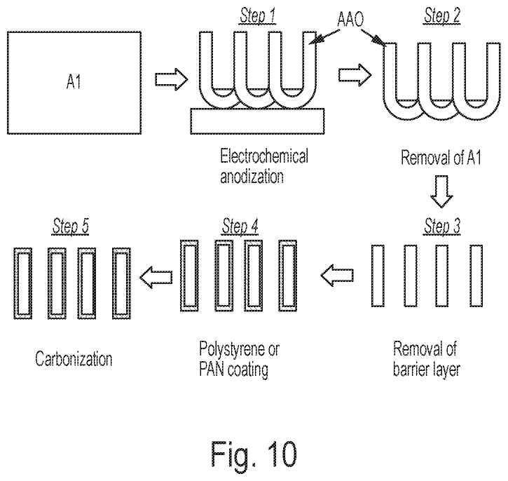

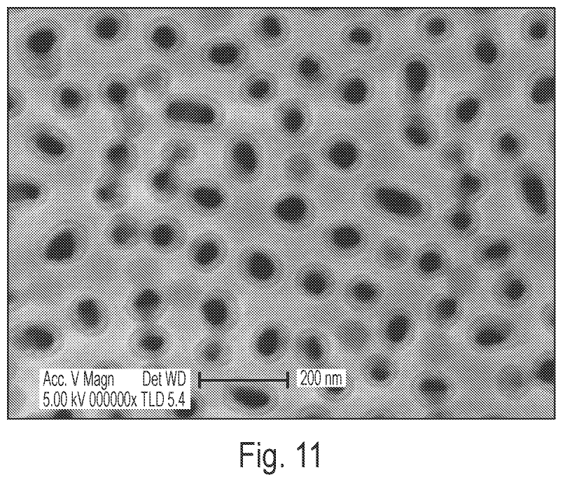

FIG. 10 shows an illustration of a step-by-step synthetic procedure for forming an electroactive membrane in accordance with some embodiments of the present disclosure. A flow diagram for fabrication of inorganic electroactive membranes is shown in FIG. 10. The general synthetic scheme is initiated by fabricating a porous AAO template of desired thickness by electrochemically anodizing aluminum foil (step 1). The AAO template is removed from the aluminum under layer by a selective chemical etching process (step 2). The alumina barrier layer is then removed by a (wet or dry) etching (step 3) process; then a thin and uniform polystyrene or polyacrylonitrile (PAN) film is deposited (step 4) using a dip coating to ensure conformal deposition, good film integrity and thickness uniformity. In step 5, hollow carbon nanotubes are synthesized by high temperature carbonization of polystyrene or PAN. All of these fabrication steps can be carried out on samples with very large areas, making this a cost-effective process.

Tuning pore diameter and pore density is achieved by first synthesizing AAO membranes with pore sizes in the range of 10-30 nm, followed by controlled tuning of carbon coating thickness both at the surface and inside of the pore walls. The pore diameter and interpore distance of AAO depends upon the anodization voltages and the electrolyte, and follows a linear relation as shown in equations (1) and (2). The pore density, defined as the ratio of the total number of pores occupying a density of 1 cm² is given by equation 3.

Dₚ=kₚU (1)

Dᵢₙₜ=kᵢₙₜU (2)

D_{den}=(2×1014)/(√3×Dᵢₙₜ) (3)

where Dₚ, Dᵢₙₜ and D_{den} are pore diameter, interpore distance and pore density, and U is the anodization potential.

After synthesis of AAO with desired pore size and pore density, inner walls and the surfaces of the alumina membrane are coated with polystyrene suspended in dimethyl formamide by drop casting followed by carbonization at higher temperatures. The thickness of the coating is controlled by tuning the concentration of the polystyrene and carbonization temperature. Other polymers, such as polyacrylonitrile, may be used for synthesis of hollow carbon tubes.

For separations, the membrane surface can be hydrophilic at the mouth of the pores to slow fouling (organic) and scaling (build-up of OH⁻ ions at the surface leading to precipitation) and hydrophobic at the inner walls for efficient ion-migration. The carbon membranes prepared, as described above, are hydrophobic. To impart hydrophilicity at the mouth, a low-temperature air oxidation step with air flow parallel to the surface is employed. Flux rate, temperature and time are optimized to spatially control (surface vs. inner walls) the hydrophobic and hydrophilic properties of the membrane. Contact angle measurements can be performed for quantitative measurement of surface wetting properties.

Tuning ion-selectivity, the ability of the membranes to reject ions, may be accomplished using potentiostatic approaches, i.e. controlling the ion-selectivity by injecting excess charge into the membrane. For example, excess negative charges can be created at the inner walls by applying a negative potential. Ions with the same charge will get repelled and counter-ions will flow through. Pore size, pore density and applied potential can also affect ion-selectivity. Another approach uses a combination of surface functionalization and electrical charge injection to achieve an ion transport number close to 1. Reversal of concentration polarization layer formed across the surface of the membrane may overcome polarization losses.

Operational parameters have been optimized to synthesize porous AAO with pore size less than 10 nm in modified H₂SO₄ electrolyte (50% H₂SO₄ and 50% methanol). The inner walls of alumina membranes (pore diameter of ˜100 nm and thickness ˜1 micron) were coated with carbonized polystyrene to form hollow core-shell structures (FIG. 10). The results will be a nanostructured conducting membrane with uniform pore size designed for selective passage of cations or anions depending on the applied voltage, and it will be electronically isolated from the photo-electrodes via an insulating water permeable support fixture.

FIG. 9(a) shows an illustration of a diffusion cell set-up for a membrane selectivity measurement in accordance with some embodiments of the present disclosure. Electrochemically active porous membranes were fabricated using the protocol described above, and their ion-selectivity was tested using a custom-built diffusion cell, in which a membrane was sandwiched between two glass cells (FIG. 9(a)). One half of the diffusion cell had a higher electrolyte concentration, C_{H} (upstream side), and the other had a lower electrolyte concentration, C_{L} (downstream side). The ratio of the downstream concentration to the upstream concentration is defined as the concentration ratio, C_{L}/C_{H}. Both halves of the diffusion cell were constantly stirred at 700 rpm. IV curves were obtained as a function of C_{L}/C_{H} ranging from 0.01 to 1 while sweeping from −150 mV to 150 mV at 2 mV sec⁻¹ between two Ag/AgCl reference electrodes on either side of the membrane. A bi-potentiostat was used to measure the transmembrane IV behavior across the membrane and the potential at zero current was recorded as the transmembrane potential, Eₘ, given in Equation 4. Thus, a plot of Eₘ versus log(aₕ/a_{L}) can be used to back-calculate the cation transport number, t₊. For an ideal cation exchange membrane, t₊ is 1.0 and t₋ is 0.0. Thus, the maximum transmembrane potential for a log(a_{H}/a_{L}) of 1.0 would be −59 mV. When neither the cationic or anionic species transports faster than the other across the membrane (i.e. a non-selective membrane), t₊=t₋=0.5, and thus Eₘ=0.0 mV.

Eₘ=(2.303RT/nF)(t₊−t₋)log(a_{H}/a_{L}) (4)

FIG. 9(b) shows a graph of trans-membrane potential as a function of applied membrane potential with the dashed line representing the theoretical maximum trans-membrane potential in accordance with some embodiments of the present disclosure. The selectivity of the fabricated nanoporous conducting membrane, as shown in FIG. 9(b), is a plot of the trans-membrane potential, Eₘ, as a function of the applied membrane potential. This data shows that ion-selectivity can be tuned by tuning the potential applied to the membrane, with increasing selectivity for cations with increasing negative potentials and vice versa for positive potentials. The results show that good cation selectivity can be achieved by tuning the applied membrane potential.

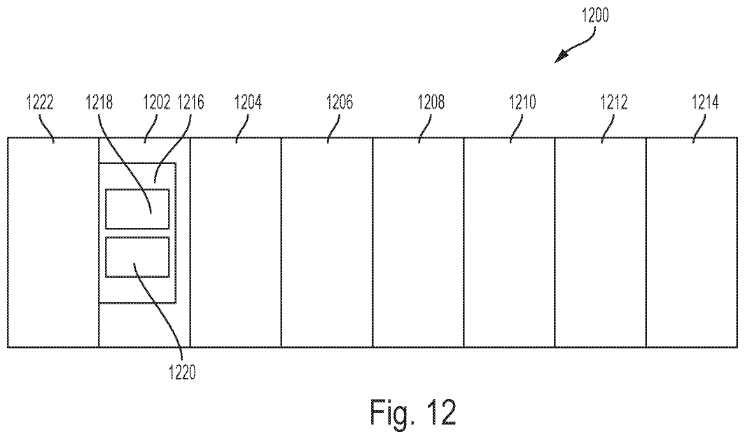

FIG. 12 shows a block diagram of a three-dimensional photo-electrodialysis 1200 including a three-dimensional electrode 1216 in accordance with some embodiments of the present disclosure. The three-dimensional photo-electrodialysis unit 1200 includes a first compartment 1202, a first electroactive cation selective membrane 1204, a second compartment 1206, an electroactive anion selective membrane 1208, a third compartment 1210, a second electroactive cation selective membrane 1212, and a fourth compartment 1214. The first electroactive cation selective membrane 1204 couples the first compartment 1202 to the second compartment 1206. The electroactive anion selective membrane 1208 couples the second compartment 1206 to the third compartment 1210. The second electroactive cation selective membrane 1212 couples the third compartment 1210 to the fourth compartment 1214. The first compartment includes the three-dimensional electrode 1216.

The three-dimensional electrode 1216 is not limited to being formed from a particular material. In some embodiments, the three-dimensional electrode 1216 includes a packed bed of conductive beads 1218 or a conductive foam 1220. Each of the beads of the packed bed of conductive beads 1218 is formed from one or more carbon silica, meso/nanoporous silica, meso nanoporous zironia, or meso/nanoporous hafnia. The conductive foam 1220 is formed of one or more of carbon, silica, meso/nanoNi, Co, Fe, Si, Ag, Au, Ru, Rh, Pt, Pd, GaAs, Si, GaN. Photoactive materials suitable for use in coating the three-dimensional electrode 1216 include cadmium telluride, copper indium di-selenide (CuInSe₂), cadmium selenide, cadmium sulfide, copper oxide, chemical bath deposited tin sulfide, electrospun iron oxide, silicon, copper sulfide, copper zinc tin sulfide, bismuth vanadate, gallium arsenide, gallium phosphide, and indium phosphide.

The electroactive anion selective membrane 1208 allows anions, such as Cl⁻, to pass through the membrane. In some embodiments, the electroactive anion selective membrane 1208 includes a plurality of cavities within a metal oxide film conformally coated or sparsely filled with one or more of carbon Ni, Co, Fe, Si, Ag, Au, Ru, Rh, Pt, Pd.

The first electroactive cation selective membrane 1204 and the second electroactive cation selective membrane 1212 allow cations, such as Na^{+,} to pass through the first electroactive cation selective membrane 1204 and the second electroactive cation selective membrane 1212.

The three-dimensional photo-electrodialysis unit 1200, in some embodiments, further includes a solar cell 1222 coupled to the three-dimensional electrode 1216. The solar cell 1222 is formed from Si, GaAs, CdTe, CdSe, GaN, CIGS, or CdS, or the mixture of thereof. When illuminated, the solar cell 1222 generates light-initiated charges.

In operation, the first compartment 1202 and the fourth compartment 1214 contain electrochemically active redox species such as sulfur (S²⁻/S₂²⁻), Iron (Fe²⁺/Fe³⁺), Cobalt (Co²⁺/Co³⁺), Selenium (Se²⁻/Se₂²⁻), Tellurium (Te²⁻/Te₂²⁻), Nickel (Ni²⁺/Ni³⁺), Manganese (Mn²⁺/Mn⁴⁺), Tin (Sn²⁺/Sn⁴⁺). The second compartment 1206 and the third compartment 1210 receive a feedstock, such as salt water. The first electroactive cation selective membrane 1204 and the electroactive anion selective membrane 1208 each selectively passes cations or anions based upon the applied charge. Thus, ions in the starting feedstock are removed from the second compartment 1206.

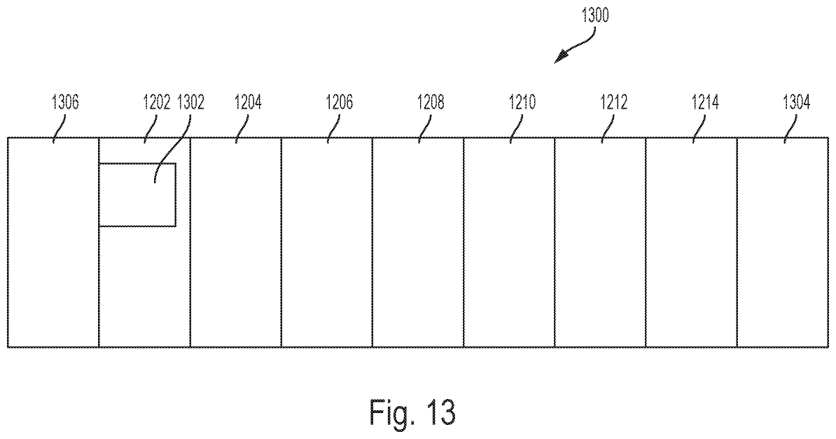

FIG. 13 shows a block diagram of an apparatus 1300 including one or more photocells 1302 in accordance with some embodiments of the present disclosure. The apparatus 1300 includes a first compartment 1202, a first electroactive cation selective membrane 1204, a second compartment 1206, an electroactive anion selective membrane 1208, a third compartment 1210, a second electroactive cation selective membrane 1212, and a fourth compartment 1214. The first electroactive cation selective membrane 1204 couples the first compartment 1202 to the second compartment 1206. The electroactive anion selective membrane 1208 couples the second compartment 1206 to the third compartment 1210. The second electroactive cation selective membrane 1212 couples the third compartment 1210 to the fourth compartment 1214. The first compartment 1202 includes one or more photocells 1302 arranged to circulate in the first compartment 1202 and to form a three-dimensional photo-electrode bed. An electrical contact 1304, such as a carbon contact, is coupled to the fourth compartment 1214 and to a transparent conductive oxide 1306 electrically coupled to the one or more photocells 1302.

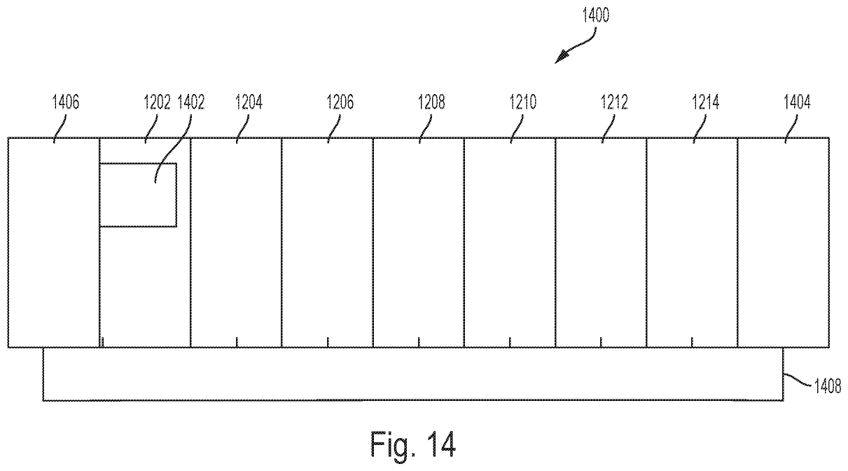

FIG. 14 shows a block diagram of an apparatus 1400 including a three-dimensional porous foam photo-electrode 1402 in accordance with some embodiments of the present disclosure. The apparatus 1400 includes a first compartment 1202, a first electroactive cation selective membrane 1204, a second compartment 1206, an electroactive anion selective membrane 1208, a third compartment 1210, a second electroactive cation selective membrane 1212, and a fourth compartment 1214. The first electroactive cation selective membrane 1204 couples the first compartment 1202 to the second compartment 1206. The electroactive anion selective membrane 1208 couples the second compartment 1206 to the third compartment 1210. The second electroactive cation selective membrane 1212 couples the third compartment 1210 to the fourth compartment 1214. The first compartment 1202 includes a three-dimensional porous foam photo-electrode 1402. An electrical contact 1404 is coupled to the fourth compartment 1214 and to a transparent conductive oxide 1406 through a connector 1408. The transparent conductive oxide 1406 is electrically coupled to the three-dimensional porous foam photo-electrode 1402.

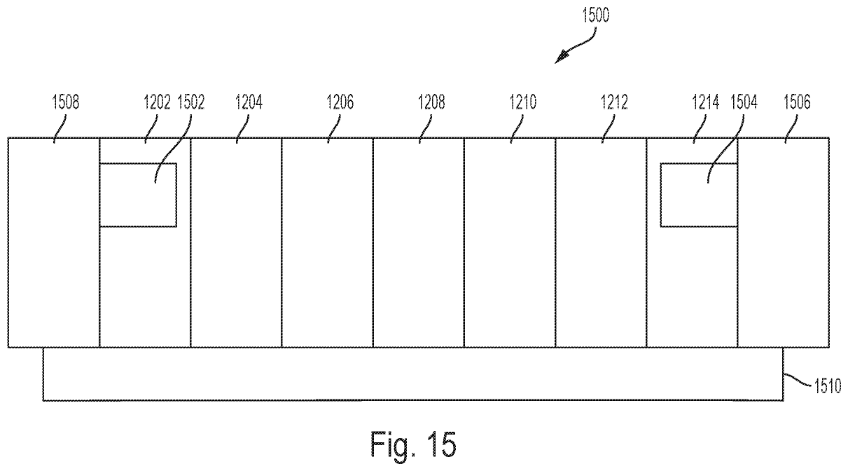

FIG. 15 shows a block diagram of an apparatus 1500 including a solar cell 1508 in accordance with some embodiments of the present disclosure. The apparatus 1500 includes a first compartment 1202, a first electroactive cation selective membrane 1204, a second compartment 1206, an electroactive anion selective membrane 1208, a third compartment 1210, a second electroactive cation selective membrane 1212, and a fourth compartment 1214. The first electroactive cation selective membrane 1204 couples the first compartment 1202 to the second compartment 1206. The electroactive anion selective membrane 1208 couples the second compartment 1206 to the third compartment 1210. The second electroactive cation selective membrane 1212 couples the third compartment 1210 to the fourth compartment 1214. The first compartment 1202 includes a first three-dimensional porous foam photo-electrode 1502. The fourth compartment 1214 includes a second three-dimensional porous foam photo-electrode 1504. An electrical contact 1506 is coupled to the fourth compartment 1214 and to the solar cell 1508 through a connector 1510. The solar cell 1508 is electrically coupled to the first three-dimensional porous foam photo-electrode 1502.

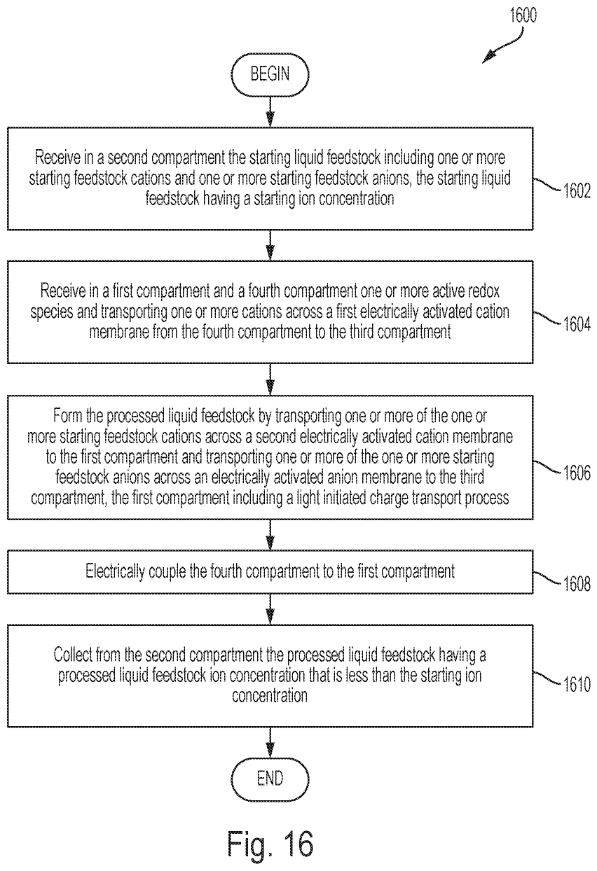

FIG. 16 shows a flow diagram of a method 1600 of forming a processed liquid feedstock from a starting liquid feedstock in accordance with some embodiments of the present disclosure. The method 1600 includes receiving in a second compartment the starting liquid feedstock including one or more starting feedstock cations and one or more starting feedstock anions, the starting liquid feedstock having a starting ion concentration (bock 1602), receiving in a first compartment and a fourth compartment one or more active redox species and transporting one or more cations across a first electrically activated cation membrane from the fourth compartment to the third compartment (block 1604), forming the processed liquid feedstock by transporting one or more of the one or more starting feedstock cations across a second electrically activated cation membrane to the first compartment and transporting one or more of the one or more starting feedstock anions across an electrically activated anion membrane to the third compartment, the first compartment including a light initiated charge transport process (1606), electrically coupling the fourth compartment to the first compartment (block 1608), and collecting from the second compartment the processed liquid feedstock having a processed liquid feedstock ion concentration that is less than the starting ion concentration (1610).

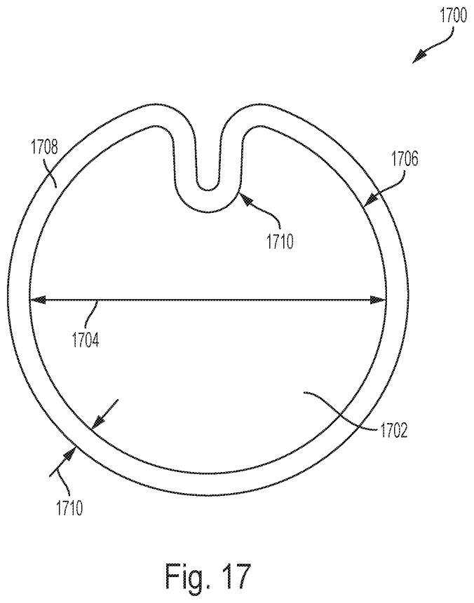

FIG. 17 shows an illustration of an apparatus 1700 including a substantially spherical particle 1702 having a photo-active coating 1702 in accordance with some embodiments of the present disclosure. The substantially spherical particle 1702 has a diameter 1704 and a surface 1706. The photo-active coating 1708 substantially covers the surface 1706 and has a thickness 1710 to produce a photo-generated current that is substantially equal to an ion-transport current across a selected membrane. In some embodiments, the substantially spherical particle 1702 includes mesoporous silica. In some embodiments, the substantially spherical particle 1702 includes nanoporous zirconia. In some embodiments, the diameter 1704 is about twenty microns. In some embodiments, the diameter 1704 is between about fifteen microns and about twenty-five microns. In some embodiments, the photo-active 1708 includes tin sulfide. In some embodiments, the surface 1706 includes a nanopore having a nanopore surface 1710 and the photo-active coating 1708 substantially coats the nanopore surface 1710.

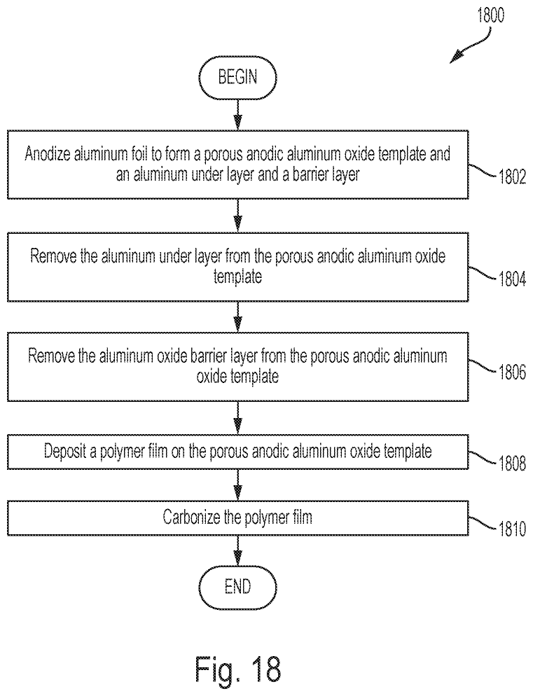

FIG. 18 shows a flow diagram of a method 1800 of forming an electroactive membrane in accordance with some embodiments of the present disclosure. The method 1800 includes anodizing aluminum foil to form a porous anodic aluminum oxide template and an aluminum under layer and a barrier layer (block 1802), removing the aluminum under layer from the porous anodic aluminum oxide template (block 1804), removing the aluminum oxide barrier layer from the porous anodic aluminum oxide template (block 1806), depositing a polymer film on the porous anodic aluminum oxide template (block 1808), and carbonizing the polymer film (block 1810).

In some embodiments, depositing the polymer film on the porous anodic aluminum oxide template includes depositing a polystyrene film on the porous anodic aluminum oxide template. In some embodiments, carbonizing the polymer film includes heating the polymer film to a high temperature.

Reference throughout this specification to “an embodiment,” “some embodiments,” or “one embodiment.” means that a particular feature, structure, material, or characteristic described in connection with the embodiment is included in at least one embodiment of the present disclosure. Thus, the appearances of the phrases such as “in some embodiments,” “in one embodiment,” or “in an embodiment,” in various places throughout this specification are not necessarily referring to the same embodiment of the present disclosure. Furthermore, the particular features, structures, materials, or characteristics may be combined in any suitable manner in one or more embodiments.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. A three-dimensional photo/electrodialysis unit comprising:
a first compartment to hold a three-dimensional electrode, and a group of one or more electrochemically active redox species;
a first electroactive cation selective membrane to couple the first compartment to a second compartment, the second compartment to provide a first feedstock;
an electroactive anion selective membrane to couple the second compartment to a third compartment, the third compartment to provide a second feedstock; and
a second electroactive cation selective membrane to couple the third compartment to a fourth compartment, the fourth compartment to hold a second group of one or more electrochemically active redox species.

2. The three-dimensional photo/electrodialysis unit of claim 1, wherein the three-dimensional electrode includes a packed bed conductive beads or a conductive foam.

3. The three-dimensional photo/electrodialysis unit of claim 2, wherein the packed bed beads conductive beads comprises one or more of carbon, silica, meso/nanoporous silica, meso/nanoporous zirconia, meso/nanoporous hafnia, meso/nanoNi, Co, Fe, Si, Ag, Au, Ru, Rh, Pt, Pd, GaAs, Si, GaN.

4. The three-dimensional photo/electrodialysis unit of claim 2, wherein the conductive foam of the three-dimensional electrode is formed of one or more of carbon, silica, meso/nanoNi, Co, Fe, Si, Ag, Au, Ru, Rh, Pt, Pd, GaAs, Si, GaN.

5. The three-dimensional photo/electrodialysis unit of claim 1, wherein the three-dimensional electrode is coated with one or more photoactive materials of cadmium telluride, copper indium di-selenide (CuInSe₂), cadmium selenide, cadmium sulfide, copper oxide, chemical bath deposited tin sulfide, electrospun iron oxide, silicon, copper sulfide, copper zinc tin sulfide, bismuth vanadate, gallium arsenide, gallium phosphide, and indium phosphide.

6. The three-dimensional photo/electrodialysis unit of claim 2, further comprising a solar cell electrically connected to the conductive foam of the three-dimensional electrode.

7. The three-dimensional photo/electrodialysis unit of claim 6, wherein the solar cell is made of Si, GaAs, CdTe, CdSe, GaN, CIGS, CdS, or a combination thereof.

8. The three-dimensional photo/electrodialysis unit of claim 6, wherein the solar cell generates light-initiated charges.

9. The three-dimensional photo/electrodialysis unit of claim 1, wherein the first compartment and the fourth compartment contain electrochemically active redox species such as sulfur (S²⁻/S₂²⁻), Iron (Fe²⁺/Fe³⁺), Cobalt (Co²⁺/Co³⁺), Selenium (Se²⁺/Se₂²⁺), Tellurium (Te²⁻/Te₂²⁻), Nickel (Ni²⁺/Ni³⁺), Manganese (Mn²⁺/Mn⁴⁺), Tin (Sn²⁺/Sn⁴⁺) or combinations thereof.

10. The three-dimensional photo/electrodialysis unit of claim 1, wherein the first electroactive cation selective membrane and the electroactive anion selective membrane each selectively passes cations or anions upon its applied charge.

11. The three-dimensional photo/electrodialysis unit of claim 1, wherein the electroactive anion selective membrane comprises a plurality of cavities within a metal oxide film conformally coated or sparsely filled with one or more of carbon Ni, Co, Fe, Si, Ag, Au, Ru, Rh, Pt, Pd.

12-29. (canceled)

30. An apparatus comprising:
a substantially spherical particle having a diameter and a surface; and
a photo-active coating substantially covering the surface and having a thickness to produce a photo-generated current that is substantially equal to an ion-transport current across a selected membrane.

31. The apparatus of claim 30, wherein the substantially spherical particle includes mesoporous silica.

32. The apparatus of claim 30, wherein the substantially spherical particle includes nanoporous zirconia.

33. (canceled)

34. The apparatus of aim 30, wherein the diameter is between about fifteen microns and about twenty-five microns.

35. The apparatus of claim 30, wherein the photo-active coating includes tin sulfide.

36. The apparatus of claim 30, wherein the surface includes a nanopore having a nanopore surface and the photo-active coating substantially coating the nanopore surface.

37. A method comprising:
anodizing aluminum foil to form a porous anodic aluminum oxide template and an aluminum under layer and a barrier layer;
removing the aluminum under layer from the porous anodic aluminum oxide template;
removing the aluminum oxide barrier layer from the porous anodic aluminum oxide template;
depositing a polymer film on the porous anodic aluminum oxide template; and
carbonizing the polymer film.

38. The method of claim 37, wherein depositing the polymer film on the porous anodic aluminum oxide template comprises depositing a polystyrene film on the porous anodic aluminum oxide template.

39. The method of claim 37, wherein carbonizing the polymer film comprises heating the polymer film to a high temperature.
